(19) United States
(12) Patent Application Publication
(10) Pub. No.: US 2012/0059700 A1
(43) Pub. Date: Mar. 8, 2012

(54) INCENTIVIZED PEER-TO-PEER CONTENT AND ROYALTY DISTRIBUTION SYSTEM

(76) Inventor: Andrew James Darbyshire, Mullumbimby (AU)

(21) Appl. No.: 13/224,660

(22) Filed: Sep. 2, 2011

Related U.S. Application Data
(60) Provisional application No. 61/379,752, filed on Sep. 3, 2010.

(51) Int. Cl. G06Q 30/00; G06F 21/22; G06F 15/16

(52) U.S. Cl. 705/14.16; 709/219; 726/28

(57) ABSTRACT

An incentivized peer-to-peer content and royalty distribution system is disclosed. This system may distribute contents including, without limitation, music files and other playable formats, videos, e-News, eZines, eBooks, software, applications, learning tools, and other types of content. The system allows users to support a product, content or artist not available through traditional distribution systems such as brick-and-mortar retailers, online retailers, and also allows users to market, promote, or solicit other users, buyers and/or promoters to license, buy or use the content they are supporting and to share in the royalties collected from the plurality of purchases occurring within the peer-to-peer, informal distribution chain. Further, the distribution system may reward users who are successful in convincing other users to license or purchase the product or content based at least in part on use and analysis of metadata associated with content transferred within an informal distribution chain.

### CROSS-REFERENCE TO RELATED APPLICATIONS

This application claims the benefit of the following commonly-owned U.S. Provisional Patent Applications, which is incorporated herein by reference in its entirety: 61/379,752, filed on Sep. 3, 2010, and entitled “INCENTIVIZED PEER-TO-PEER CONTENT AND ROYALTY DISTRIBUTION SYSTEM.”

### BACKGROUND

1. Field

The invention is related to peer-to-peer content distribution within informal distribution chains, and the allocation of incentives and rewards among participants within the distribution chains.

2. Description of the Related Art

Distribution of content, such as music, books, movies, visual works, and the like, has historically been constrained by the limitations of traditional industry distribution chains, such as where producers and publishers promote a limited number of works with mass-market advertising, for sales in brick-and-mortar or online stores. The emergence of increased peer-to-peer contact among consumers, such as through social networking, has created alternative channels for distribution among consumers, but such channels are typically highly informal, often failing to reward artists, authors, promoters, or the like, for successful works. A need exists for more effective informal content distribution systems.

### SUMMARY

Disclosed herein are certain preferred embodiments of an incentivized peer-to-peer content and royalty distribution system (the “incentivized peer-to-peer distribution system”). In embodiments, the system may allow its users to support a product, content or artist, including those that are not available through traditional distribution systems such as brick-and-mortar or online retailers. In embodiments, various types of users may promote, share, and distribute content, such as digital media files, within an informal distribution chain, being rewarded for successful promotion, such as a subsequent purchase by a participant in the informal distribution chain. By attaching rewards for the successful promotion of the content items, the system takes advantage of increased peer-to-peer content available in social networks and other informal distribution chains, while appropriately rewarding the creation and promotion of successful works.

In embodiments, the present invention may provide a method and system for associating metadata with a digital file, wherein the metadata is comprised of at least one of (a) a digital tag identifying the content of the digital file, (b) a digital tag identifying a sponsor, c a digital tag identifying a customer, and/or (d) a digital tag specifying a license term relating to the use of the digital file by a customer. An indication of a transmission of the digital file from a client device that is associated with a first consumer to a client device that is associated with a second consumer may be received, wherein the transmission from the first consumer to the second consumer occurs within an informal distribution chain, and metadata associated with the digital file may be updated to include a digital tag identifying the second customer within the informal distribution chain and a digital tag indicating that the digital file was received by the second customer from the first customer.

In embodiments, metadata associated with the digital file may be further updated to include digital tags identifying a plurality of additional customers that are added to the informal distribution chain and the customers from whom the digital file was received. The metadata may be stored within code of the digital file, and/or stored in a location remote to the digital file. The location remote to the digital file may comprise a server that is associated with a content distribution system, wherein the content distribution system enables at least in part management and distribution of digital files.

In embodiments, the license term provided within the metadata may state at least in part a duration of time that the digital file may be used by a customer in the informal distribution chain without payment.

In embodiments, the transmission of the digital file from the first customer to the second customer causes the second customer to be automatically searched for within a content distribution system and registered with the system if the search does not find the second customer within the system. The registration of the second customer may be based at least in part on using a phone number associated with the second customer as a membership identifier within the content distribution system. The registration of the second customer within the content distribution system may include an automated query for the second customer to enter a payment account to associate with the second customer's membership.

In embodiments, the client device may be an audio visual playback device, a cellular phone, or some other type of client device that is capable of playing digital files.

In embodiments, a first indication of a transmission of a digital file from a first consumer to a second consumer may be received, wherein the transmission from the first consumer to the second consumer occurs within an informal distribution chain, and wherein the first indication of the transmission may be received at a server associated with a content distribution system that includes at least one web service. Metadata associated with the digital file may be updated to include a first digital tag identifying the second consumer within the informal distribution chain and a second digital tag indicating that the digital file was received by the second consumer from the first consumer. A second indication of a transmission of a digital file from the second consumer to a third consumer may be received, wherein the transmission from the second consumer to the third consumer occurs within the informal distribution chain, and wherein the second indication of the transmission may be received at the server associated with the content distribution system. Metadata associated with the digital file may be updated to include a third digital tag identifying the third consumer within the informal distribution chain and a fourth digital tag indicating that the digital file was received by the third consumer from the second consumer. A payment may be received at the content distribution system from the third consumer, wherein the payment enables at least a continued, licensed use of the digital file by the third consumer, and a first royalty may be distributed to the first consumer and a second royalty distributed to the second consumer upon receipt of the payment from the third consumer, wherein the first and second royalty amounts are based at least in part on a position of the first and second consumers within the informal distribution chain.

In embodiments, the first and second royalties may be monetary payments, reward points, or some other type of benefit or compensation. Reward points may be redeemable for goods and services through the content distribution system. The first royalty may be paid into a payment account that is associated with the first consumer's membership in the content distribution system, and wherein the second royalty may be paid into a payment account that is associated with the second consumer's membership in the content distribution system.

In embodiments, a server associated with a content distribution system may receive an indication of a transmission of a digital file from a client device that is associated with a first consumer to a client device that is associated with a second consumer, wherein the transmission from the first consumer to the second consumer occurs within an informal distribution chain and is made using a near-field communication protocol. Metadata associated with the digital file may be updated to include a first digital tag identifying the second consumer within the informal distribution chain and a second digital tag indicating that the digital file was received by the second consumer from the first consumer. In embodiments, the near-field communication protocol may be Bluetooth, or some other near-field communication protocol. In embodiments, the updated metadata may be automatically transmitted to a server that is associated with the content distribution system. The updated metadata may be stored locally on the client device that is associated with the second consumer, and automatically transmitted to the server that is associated with the content distribution system upon the second consumer logging in to his content distribution system web service account.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a simplified architecture for a content distribution system.

FIG. 2A depicts an example embodiment of an informal distribution chain and a corresponding example embodiment of digital tag data that may be associated with each consumer within the informal distribution chain.

FIG. 2B depicts an example embodiment of digital tag data recording content, sponsor, and consumer data that may be associated with each consumer within the informal distribution chain.

FIG. 3 depicts a simplified depiction of an informal distribution chain and the corresponding content tags that may be provided by the content distribution system.

FIG. 4 depicts a simplified digital tag method in which the tag includes unique data corresponding to content and consumer, and variable source identification data.

FIG. 5 depicts an example billing protocol that may be used by the content distribution system.

FIG. 6 depicts a royalty distribution protocol within a simplified informal distribution chain.

FIG. 7 depicts content license renewal and revocation within a simplified informal distribution chain.

FIG. 8 depicts example monthly processes that may be enabled by the content distribution system.

FIG. 9 illustrates a simplified example of an informal distribution chain in which there are non-paying sponsors.

FIG. 10 depicts a simplified summary of components of a registration process of the content distribution system.

FIG. 11 depicts a simplified summary of components of transaction processes of the content distribution system.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting, but rather to provide an understandable description of the invention.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

### Incentivized Peer-to-Peer Distribution

The present invention discloses an incentivized peer-to-peer content and royalty distribution system (the “incentivized peer-to-peer distribution system”). In examples, the incentivized peer-to-peer distribution system may distribute contents including, without limitation, music files (e.g., MP3, .wav, and the like) and other playable formats, videos, e-News, eZines, eBooks, software, applications, learning tools, or some other type of content or commodity. In an embodiment of the invention, the incentivized peer-to-peer distribution system may allow its users to support a product, content or artist, including products, content and artists that are not available through traditional distribution systems such as brick-and-mortar retailers, online retailers (e.g., iTunes and other media purchasing platforms), and may also allow users to market, promote, or solicit other users, buyers and/or promoters to license, buy or use the content they are supporting and to share in the royalties collected from the plurality of purchases occurring within the peer-to-peer distribution chain. Further, the incentivized peer-to-peer distribution system may reward the users who are successful in convincing other users to license or purchase the product or content. Further, within the incentivized peer-to-peer distribution system, content creators and/or suppliers may also be rewarded for their efforts in preparing the content and making it available through the incentivized peer-to-peer distribution system. A content creator and/or supplier of products or content, as used herein, may also be referred to as a “vendor.” A licensor, purchaser, customer, consumer or user of a product or content obtained from a vendor may be referred to herein as a “consumer,” “member,” “customer,” or “sponsor.” The incentivized peer-to-peer distribution system, as described herein, may also be referred to as a “content distribution system.”

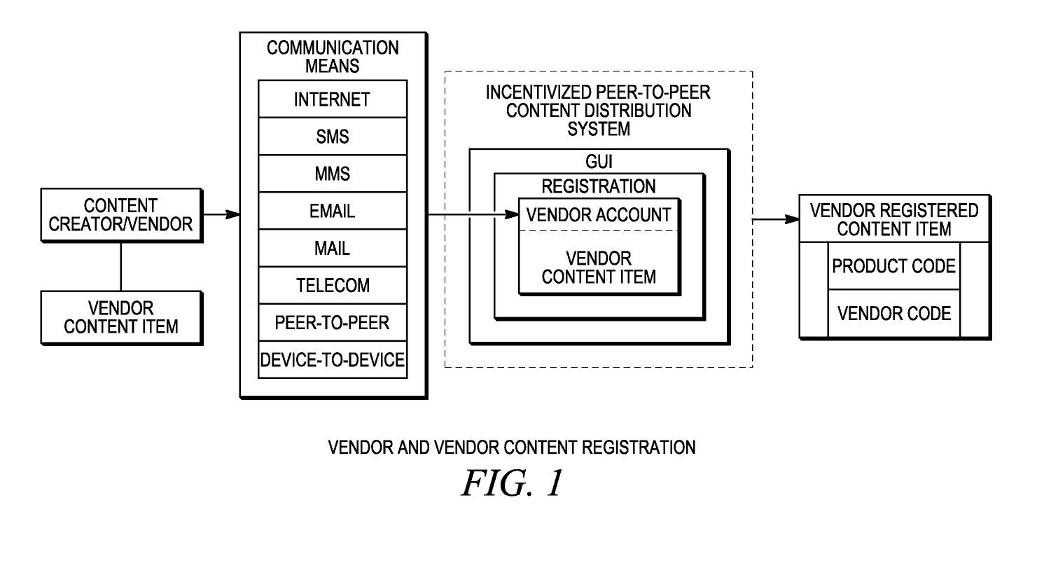

Referring to FIG. 1, a content item, such as a digital music file, may be associated with a content creator. In an embodiment, the content creator may be the artist that created the content item. In another embodiment, the content creator may be a vendor that is someone other than the creator of the content item, such as a person with permission, license or some other right to register the content item within the content distribution system. The content creator may become a vendor of the content item by registering as a user of the incentivized peer-to-peer distribution system and registering the content item within the content distribution system. The registration process may be manual or automated, including an automated registration that is prompted by opening and/or interacting with the content (such as opening a digital media file). The registration may occur using a plurality of communication means including, but not limited to, the Internet, SMS, MMS, email, ground mail, telecommunications, peer-to-peer communication, device-to-device communication, or some other means of communication. A graphic user interface within the content distribution system may facilitate registration of the content creator and content item as components of the system. Following registration, the content item may become a registered content item that is tagged with a product or content code and a vendor code. The product and vendor codes may be used to track the distribution, licensing, usage, and royalties associated with the content as it is shared among users of the content distribution system.

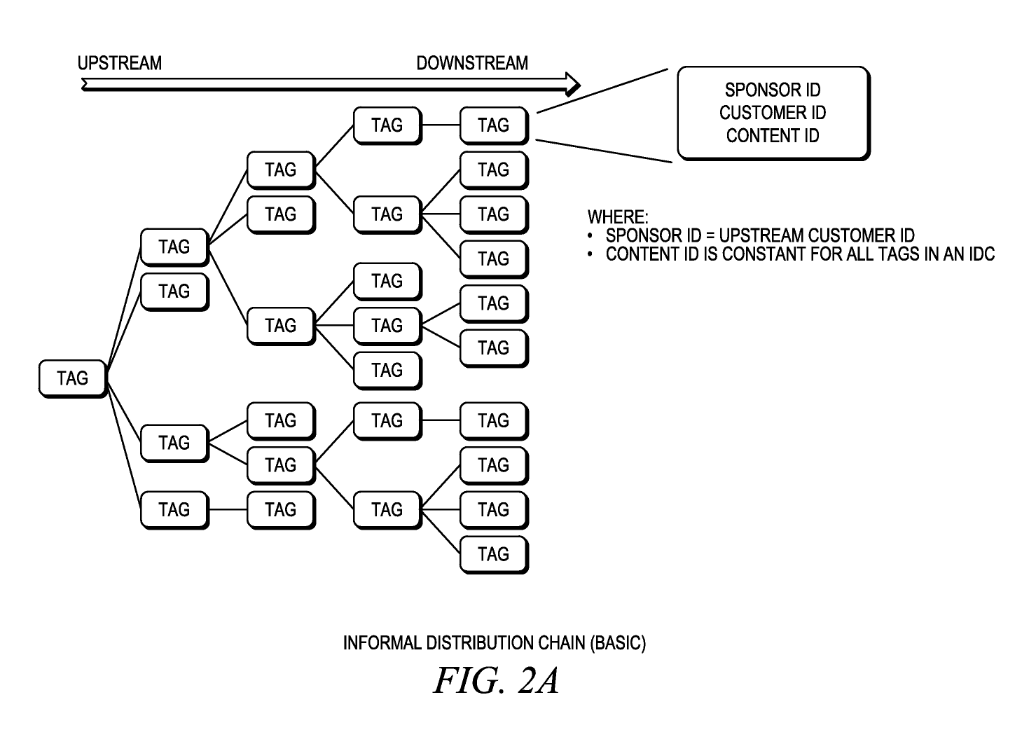

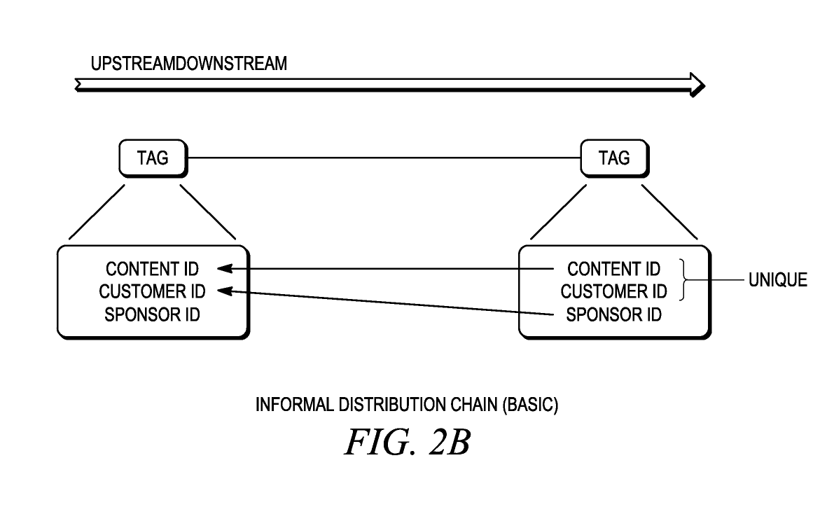

In an embodiment of the present invention, the incentivized peer-to-peer distribution system may include a distribution instance. The distribution instance may be determined by an action of a vendor or sponsor promoting, licensing, selling, and/or distributing a product or content to another user. This distribution may be recorded by associating a tag with the content, as described herein. In such transactions, a person issuing/distributing a product may be called a “sponsor” and a person receiving/buying the product may be called a “member”. The member may in turn issue/sell the product to a second customer thus becoming a sponsor for that customer. The customer may further become a member and distribute to some other customer. Accordingly, the member may become a sponsor. The collection of these connected distribution instances may constitute a chain. In an embodiment, the chain may be termed as an Informal Distribution Chain (IDC). The IDC may include a chain of sponsors and members. One IDC may apply to one product or content item. The sponsor/member relationship may be different for different products and content. FIG. 2A depicts a simplified embodiment of a tag that may be associated with an item of content that is distributed within an informal distribution chain according the methods and systems of the present invention. A Tag may provide an atomic element that indicates a position in, and further builds, an IDC. A Tag may be a record of one customer/member of the incentivized peer-to-peer content distribution system passing a content item to another person. In an example, a content item may be a particular recording of a musical composition, such as “All You Need is Love” by the Beatles. Three elements may make up a tag record including, but not limited to, a Member Id of the member passing the content item, the Content Id of the unique content item passed and the Member Id of the receiving person. These are referred to respectively as the Sponsor Id, the Content Id and the Customer Id. The tag record may be made unique by the Content Id and the Customer Id. In an embodiment, the content distribution system may prevent another combination of these two elements with a different Sponsor Id. In the event that a Sponsor Id element is unknown, it may default to a root Member Id which belongs to the content distribution system. Thus, each tag record used within the content distribution system may be unique.

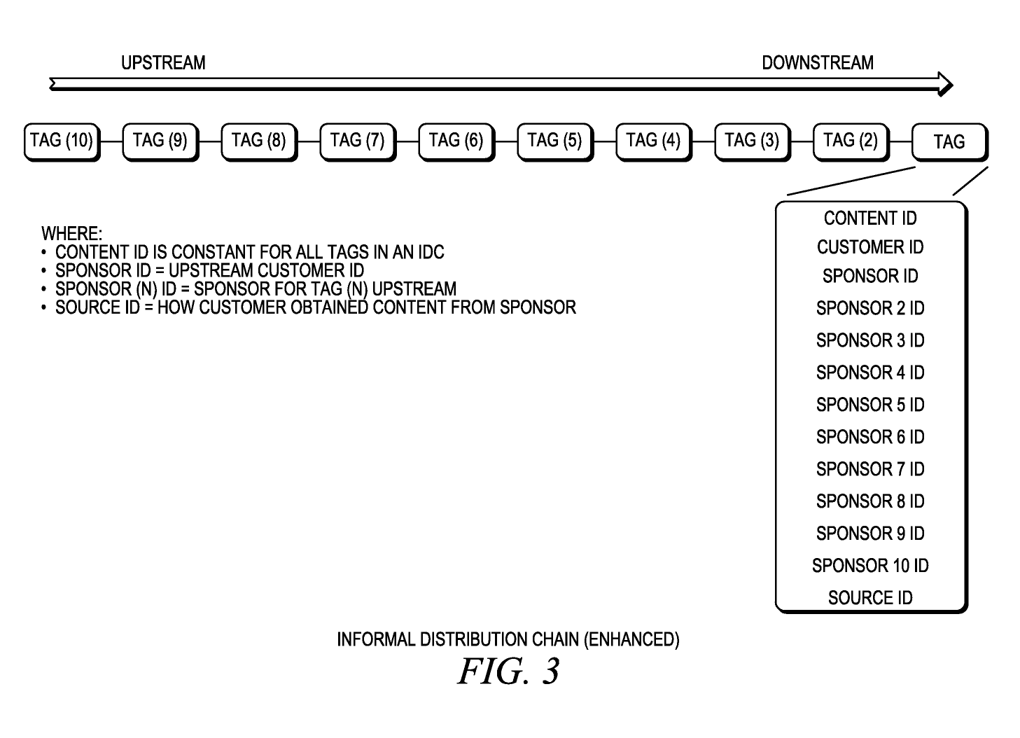

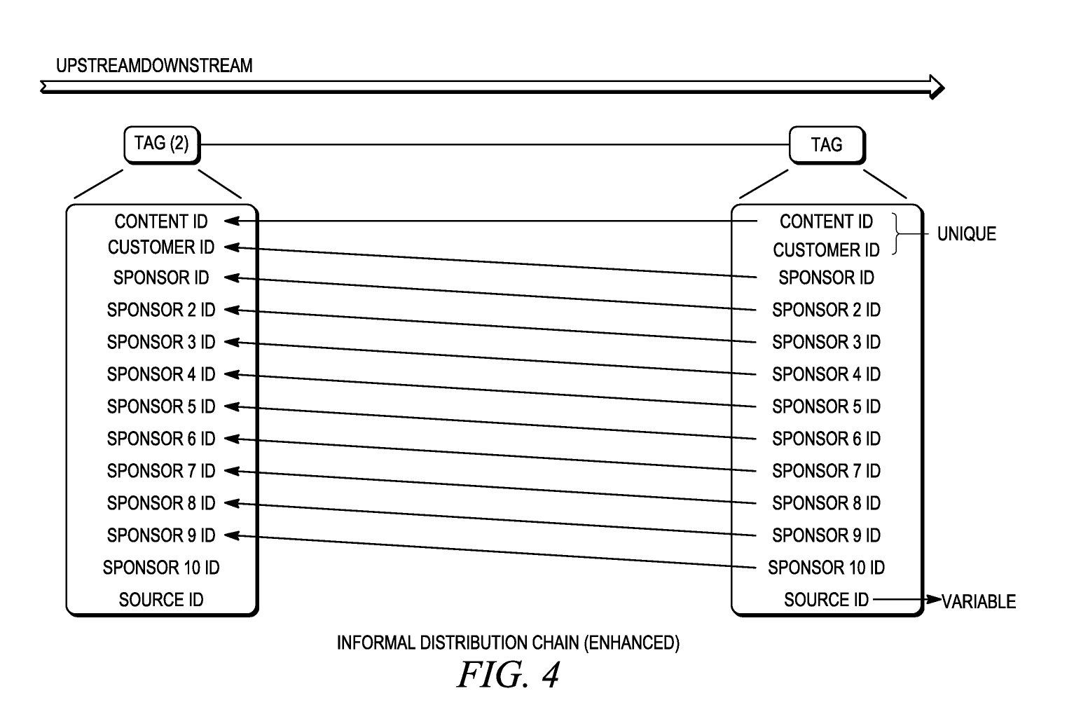

Referring to FIGS. 2B through 4, in an example, an Informal Distribution Chain (IDC) may be a construction of the unique content tag records joined together in the following manner: a first tier of tags (i.e., the beginning of the distribution chain) may have a root Member Id (such as an ID provided by the content distribution system) as the Sponsor Id. The next tier of tags below this in the distribution chain may have the previous (connecting) tag's Customer Id as the Sponsor Id, and so on (See FIG. 2B). The Content Id may remain constant in each instance of an IDC. Every Content Item will have a distinct IDC. FIGS. 3 and 4 provide simplified depictions of an informal distribution chain and the corresponding content tags that may be provided by the content distribution system.

In embodiments, the nature of an IDC may be a tiered structure where the IDC can become wider and longer at any point in its growth (i.e. more tags can be created at the root or any other level at any time). In an example embodiment, the content distribution system may require that once a member has been tagged as a Customer for a particular Content Item, they cannot be tagged again for that particular Item.

In a sample embodiment of the present invention, at a Step 1 a vendor may distribute content to a customer, referred to here as “Sponsor 1.” The content may be tagged, as described herein, so that the content may be tracked by the content distribution system and the content associated with a member. The tagged content may be received by Sponsor 1, such as through a digital file download. Upon receipt and/or opening the file or otherwise interacting with the tagged content, the content distribution system may automatically register Sponsor 1 as a user/sponsor within the content distribution system. At Step 2, subsequent to Sponsor 1 downloading the tagged content that was received from a vendor, Sponsor 1 may distribute the content to another customer, here referred to as Sponsor 2. The content tag may be updated, as described herein to include a Sponsor 1 identifier. Upon receipt and/or opening the file or otherwise interacting with the tagged content, the content distribution system may automatically register Sponsor 2 as a user of the content distribution system.

A customer as described herein may also be referred to as a member, or a downstream distributor. Similarly, a sponsor as described herein, may also be referred as to as an upstream distributor. These terms are generally meant to be interchangeable, except as would be understood based on context.

In an embodiment of the present invention, the IDC may not involve any formal contract between a sponsor and a member. The relationship may be implied on a transaction-by-transaction basis by virtue of the sponsor distributing to the customer. As described above, the downstream customer, may then become a member and may then act as a sponsor to distribute to another customer. Further, the relationship may be volatile, i.e., the relationship may only apply for one distribution instance, or a plurality of distribution instances.

In an embodiment of the present invention, the incentivized peer-to-peer distribution system may be designed for digital products that may be replicated. Therefore, the member may also be responsible for the replication.

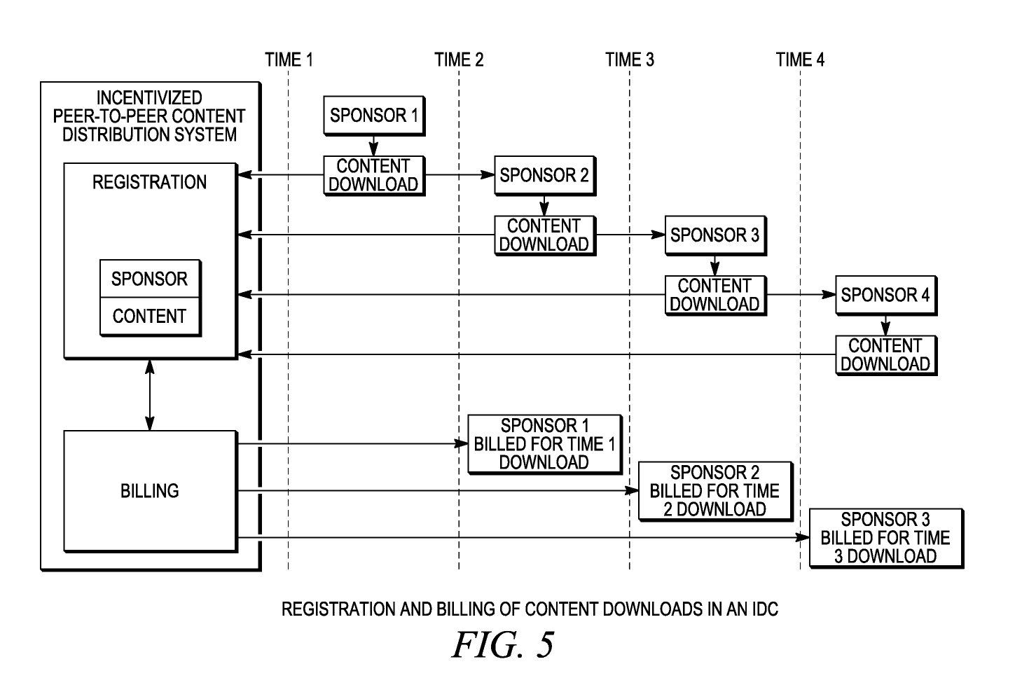

Referring to FIG. 5, a customer or sponsor of content may be permitted to download, use and interact with content for a limited period prior to receiving a periodic billing. For example, as depicted in FIG. 5, a Sponsor 1 may download a content item at a Time 1, but not be billed for the content, or requested to pay for the content, until a later, Time 2. The billing period may be set by the content distribution system such that all periodic bills are forwarded to customers/sponsors on the same day, or the in another embodiment, the periodic billing may be scheduled according to when a content was downloaded. In embodiments, a periodic bill may include a plurality of content items that were downloaded in the preceding billing period. For example, if the billing period is a monthly billing cycle, a sponsor may download, use and interact with a plurality of content throughout the month without having to respond to a bill or request for payment. Once the monthly billing cycle ends, a bill or request for payment may be sent to the customer that includes all of the content items downloaded in the preceding billing period. In this way, a customer/sponsor may use a single payment to purchase a plurality of content which is downloaded across a plurality of time points without having to individually purchase each content item at the moment of download. Further, the bill may be organized as a menu within which the customer/sponsor may select and/or deselect a subset of content items to purchase from the totality of all downloads made in the billing period.

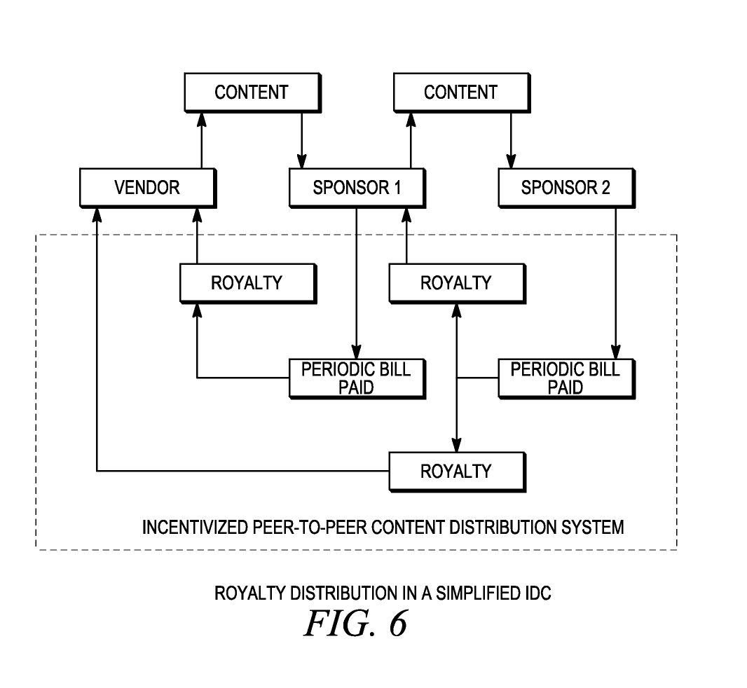

Referring to FIG. 6, once a content item is purchased by a customer, that customer may be referred to as a sponsor, meaning that the customer may now, in turn, distribute the same content to other customers with the expectation of receiving a royalty on subsequent purchases of the content made by downstream customers in the distribution chain. The purchase made by the customer may generate a royalty payment to the party from whom the content was received (and a royalty or commission to all other prior parties that participated in the distribution chain leading to the customer's current purchase). For example, still referring to FIG. 6, a vendor may distribute a content item to a customer (Sponsor 1) who ultimately purchases the content when presented with a periodic bill. Once the periodic bill is paid by the customer, the customer becomes a sponsor and a royalty payment is sent to the vendor from whom Sponsor 1 received the content. Because Sponsor 1 paid for the content, Sponsor 1 may now distribute the content with the expectation that it will receive a royalty for purchases made by other customers to whom Sponsor 1 distributes the content. Continuing the example, Sponsor 1 then distributes the content to a second customer, Sponsor 2, who pays for the content when presented with a periodic bill. The payment for the content made by Sponsor 2 may generate a royalty payment to Sponsor 1, from whom Sponsor 2 received the content, as well as a commission payment to the vendor who is a preceding party in the distribution. In embodiments, the royalty payments may be graduated, scaled, limited, or varied according to the methods and systems as described herein.

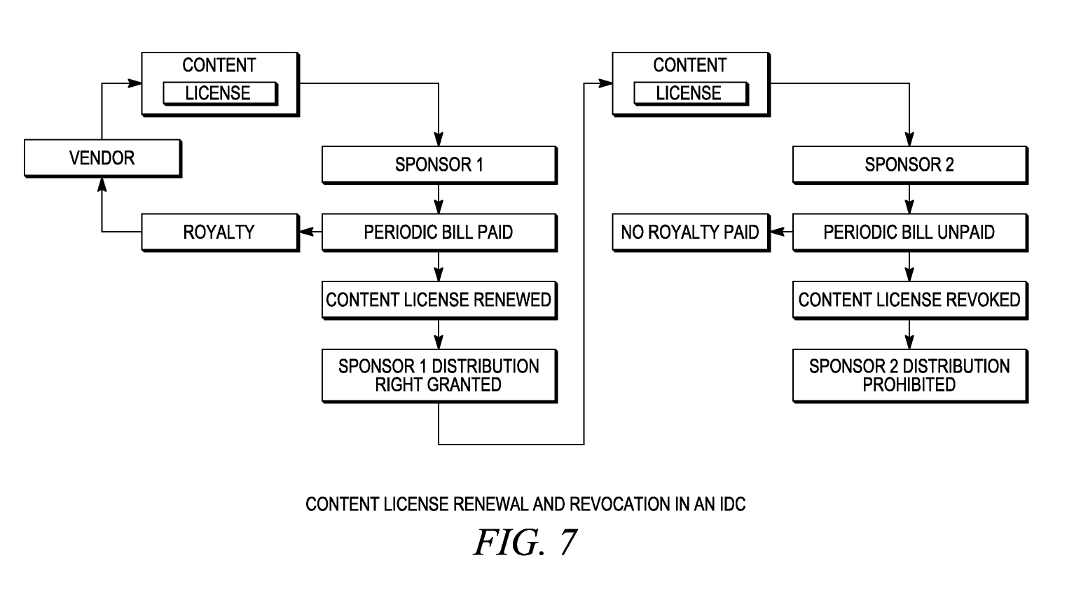

Referring to FIG. 7, a customer of content that is distributed within an informal distribution chain affiliated with the content distribution system may be provided with a license to use and interact with the content for a limited period of time, beginning immediately upon receipt. In an embodiment, the limited period of time may be the period of time between when the content is received by the customer/sponsor and when the customer/sponsor is billed for the content, such as a periodic bill generated by the content distribution system on a monthly basis. As shown in FIG. 7, Sponsor 1 may download content that is distributed from a vendor, or some other sponsor. This download may cause Sponsor 1 to become registered in the content distribution system if she is not already registered. The registration of Sponsor 1 may also enable Sponsor 1 to be entered into a billing system of the content distribution system. Upon receipt of the content, Sponsor 1 may be provided a license to use and interact with the content. In one embodiment, this license may require no action on the part of the sponsor to make it effective; it may become effective at the moment of download. The terms of this license type may be presented to a user as part of the registration process. In another embodiment, the license may become effective only after a sponsor agrees to its terms and conditions. The terms and conditions may be presented to the user at the moment of content download and/or usage. Following a defined time period, such as a monthly billing cycle, the content distribution system my issue a periodic bill to Sponsor 1 for the content that was downloaded. Continuing the example in FIG. 7, Sponsor 1 elects to purchase the content when presented with the periodic bill. Payment of the periodic bill generates a royalty payment to the vendor, from whom Sponsor 1 received the content. Payment also renews Sponsor 1's license to the content and updates the license to include a distribution right. Continuing the example further, after payment of the periodic bill, Sponsor 1 distributes the content to Sponsor 2. Sponsor 2 is granted a license to use the content until presented with a periodic bill. In this example, Sponsor 2 decides to allow the periodic bill to go unpaid. Once the due date for payment lapses without Sponsor 2 purchasing the content, Sponsor 2's license to the content is revoked. The revocation may be in the form of a written revocation informing Sponsor 2 that they are to discontinue usage of the content. Alternatively, the revocation could be in the form of a technological access restriction, such as a time bomb or other timed access bar that prevents the user from being able to fully interact with the content. Further, as depicted in FIG. 7, because Sponsor 2 did not purchase the content, no royalty is paid to the parties upstream from Sponsor 2 in the distribution chain (vendor and Sponsor 1), and Sponsor 2 is not granted a right to redistribute the content. In an alternate embodiment, Sponsor 2 may be permitted by the content distribution system to further distribute the content which Sponsor 2 did not purchase (e.g., to other parties that might be interested in purchasing the content), but Sponsor 2 may be barred from receiving any royalties resulting from downstream content purchases made within the distribution chain to which Sponsor 2 contributes the content.

In a simplified example of the present invention, a vendor and/or sponsor may be rewarded, such as through a shared royalty, by promoting, selling, or licensing a product or content to a downstream customer. For example, a creator of a particularly good pumpkin pie recipe may choose to market, solicit, or promote his recipe using the methods and systems herein in order to obtain a royalty on the licensing, purchase, and/or use of the recipe. Is this example, as an individual, the creator of the recipe may not have access to traditional means of distribution of recipe, such as publishing, and may instead choose to make the recipe available through the incentivized peer-to-peer distribution system. As a creator of the work, upon making the recipe available within the incentivized peer-to-peer distribution system, the creator may become a vendor of the recipe and may further market, promote, distribute, and/or sell that recipe, as a sponsor, to other users. Upon each license, sale or use of the recipe by a secondary user (i.e., customer), the sponsor may collect a royalty through the peer-to-peer distribution system (as described in greater detail below). The customer, in turn, may chose to become a distributor of the same recipe, register himself as a distributor of the recipe and receive a license to further market, promote, distribute, and/or sell to additional customers of the recipe. In an embodiment, the registration process may be implicit in the act of distributing the recipe; once the user chooses to distribute the recipe, the act of distribution may register the user within the incentivized peer-to-peer distribution system. At a future time, the user may be asked to complete a more detailed registration. Upon the license or sale of the recipe to these customers, the secondary user and the sponsor may each collect a shared royalty. This informal distribution network may be perpetuated ad infinitum, with each distributor in the distribution chain collecting a portion of a shared royalty for each license and or sale of a product or content, like a recipe, to a new customer.

In embodiments of the invention, the incentivized peer-to-peer distribution system may depend upon various factors such as category demand, product quality (or appeal), referral incentive, and the like, to be effective. Such factors may constitute a Word of Mouth Potential (WOMP) factor.

In embodiments, the incentivized peer-to-peer distribution system may include a member storefront. The sponsors may present the member storefront with shopping cart functionality similar to a traditional electronic shopping cart application. In embodiments, the shopping cart functionality may hand-off transactions to the content distribution system for processing. For example, the content distribution system may direct a customer back to a sponsor's site once the customer has selected a few products or content items. At this point in the transaction process, the content distribution system may tag products against the customer's account without collecting any payment from the customer.

In another embodiment of the present invention, the incentivized peer-to-peer distribution system may include a reminder facility. The reminder facility may enable the content distribution system to periodically send reminders to members and their sponsors. For example, the reminders may be for the purpose of converting tagged products to paid products, thereby giving full license to the paid product or content, for sending messages of encouragement when sponsors have their IDC's grow to a certain size, and the like.

In an embodiment of the present invention, the incentivized peer-to-peer distribution system may include an effective distribution (ED) facility. The ED facility may facilitate a product that has already been distributed downstream, to be paid for by the downstream customer. Further, a customer may not act as an effective sponsor until they have paid for the product themselves. In some cases, a distributor or member may nominate a sponsor who may be ineffective. In such cases, the IDC may remain intact with the ineffective sponsor no longer receiving royalty or commissions from the downstream distributions. In accordance with the embodiment, a member may not be treated as a sponsor unless they have paid for the product themselves prior to the downstream distributor paying.

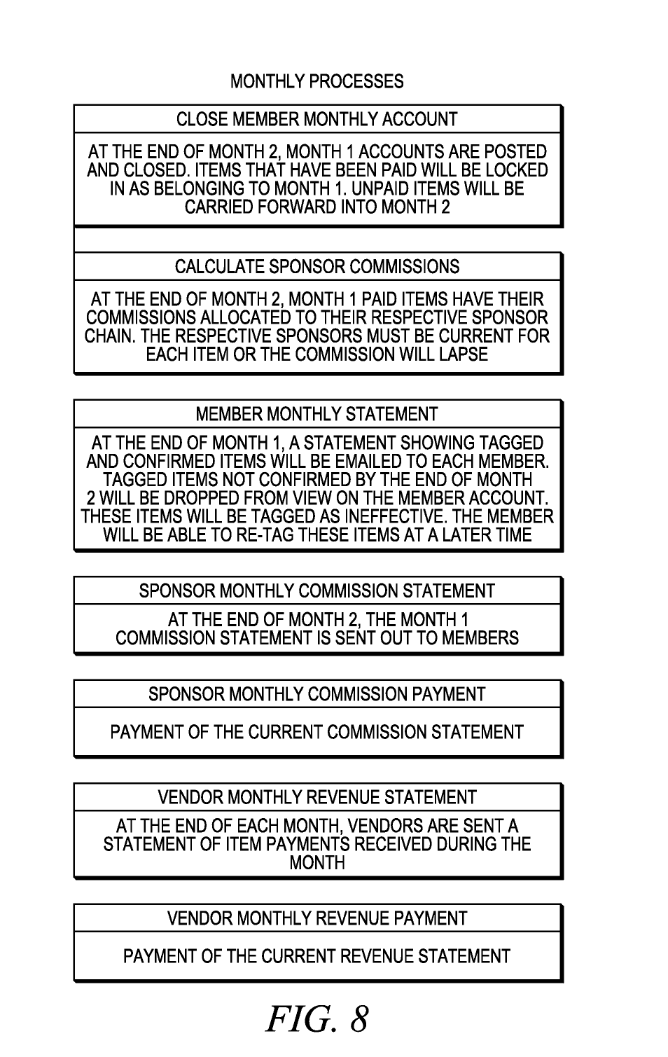

In another embodiment of the present invention, the incentivized peer-to-peer distribution system may include a central payment facility. The central payment facility may enable all payments to be made directly to the content distribution system. For example, the central payment facility may send all payments for distributed products and content happening through the IDC, to the incentivized peer-to-peer distribution system. Further, the system may accumulate all the transactions for its customers and thus may allow them to pay for multiple products and content using a single payment, made on a periodic basis. For example, a customer may select a plurality of products of interest and mark them for later payment. The customer may mark the products either on-line or by sending a text message to a regional short code. Once the customer marks a product, the customer may be covered by a license for possessing and previewing the product. The customers may thereafter visit their on-line account and may confirm or delete the products marked for later payment. After finalizing the products, the customer may make a batch payment through PayPal, Credit Card, or using some other payment means. FIG. 8 provides a simplified summary of sample embodiments of a monthly billing process that may be used the incentivized peer-to-peer distribution system.

In embodiments, an IDC may include a chain of sponsors and members. Each subsequent level of sponsors and members may give rise to a new generation. For example, a sponsor may distribute a first product to a first customer. Further, the first customer may sell the first product to a second customer. In this case, the first customer, now the sponsor, may be referred to as a second generation sponsor. In an exemplary embodiment of the present invention, rewards, such as royalty payments, may be associated up to the tenth generation. Therefore, the IDC may end at generation 10. In this case, the sponsor may be the sponsor of the IDC till generation 10 i.e., Sponsor>Generation 2> . . . Generation 10. Thus, a tree structure may be formed where each generation may potentially be larger than an earlier generation.

In embodiments, the WOMP factors may facilitate the IDC to produce various generations as determined by the WOMP factor of each product. For example, each sponsor may generate two distributors or members. The size of generating 10 distributions may be 1,024 with total distributions being 2,048 as may be calculated with the help of the below mentioned formula,

$$Gen 1 - 10 total = {\sum }_{n = 1}^{10} {w}^{n}$$

In the above example, the WOMP factor (represented by “W”) is 2. Likewise, a WOMP factor of 3 may produce a total of 88,572 distributions over 10 generations.

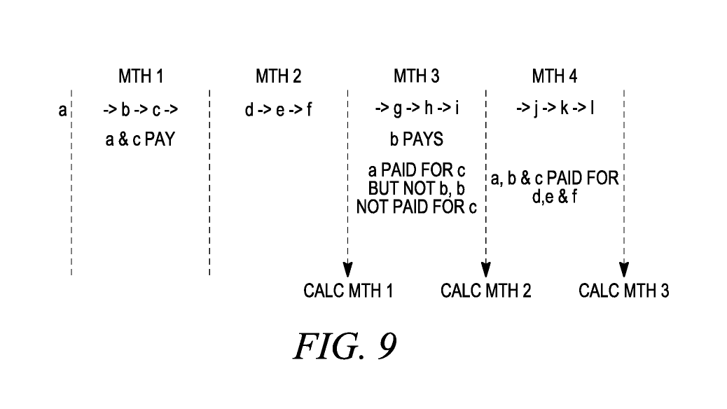

In another embodiment of the invention, the IDC may include sponsors that successfully pay for an item of content and sponsors that fail to pay for an item. FIG. 9 illustrates a simplified example of an IDC in which there are non-paying sponsors. The example scenario depicted is based on an assumed linear, 1-to-1 distribution, but it will be appreciated by one skilled in the art that other embodiments of an IDC including non-paying sponsors that is supported by the present invention may include a branched distribution tree. In the sample distribution in FIG. 9, the party “b” is a non-payer at one point in time, but who later converts a transaction to become a payer. In this model, the IDC is preserved, but on the milestone where commissions are calculated and “b” is not current because of his non-payment, “b” misses out on their commission, royalty payment, or other reward that may result from subsequent content transactions within the distribution chain. At a later milestone where “b” is current, having now paid for the content, commissions may be paid for the relevant period, but not for the period prior where “b” was not current, that payment is lost to “b.” The lost payment may be retained by the incentivized peer-to-peer system, distributed among other, paying sponsors, provided directly to the creator of the content, or some other revenue allocation performed. Further, as depicted in FIG. 9, because party “b” was not current in his payment for content, party “a,” the party responsible for the distribution to “b”, is never paid for the ultimate, later payment by “b”. Thus, in this sample embodiment, the IDC may be preserved in spite of the presence of non-payors, and there may be qualification windows for commissions that will be missed for distributors or members that are not current at the closure of the window.

In another embodiment of the invention, a combination of various products and content, each being distributed by an ad hoc network, may be determined by a random construction of sponsor-member relationships for each product. Such relationships may form a complex distribution network.

In embodiments of the present invention, the incentivized peer-to-peer distribution system may provide relationships between sponsor and member on a product-by-product basis. The relationships as described above, may not have a fixed hierarchy. For example, the relationships may be A>B>C>D for one product and B>D>A>C for another. Alternatively, there may be distribution relationships that are based on social networks. The social networks may include networks of, such as family, friends, clubs, on-line communities, or any other. In such events, embodiments of the invention may support patterns that occur by virtue of the underlying social networks.

The incentivized peer-to-peer distribution system may provide statistics one or more generation deep on distributor or member performance to sponsors. This may allow sponsors to set up their own proprietary reward systems for members they regularly supply.

In another embodiment of the present invention, an Application Programming Interface (API) may be provided to the members. The API may be used by the members to provide customer and product information. In embodiments, the customer information may include their e-mail address, phone number, or any other type of information that would enable customer identification. In embodiments, the product information may correspond to each customer, indicating the products sourced by the customer. The product information may include product codes. Embodiments of the system of the present invention may use the customer and product information to complete registration of the customer with the word of mouth content distribution system. The complete registration is explained in detail in the subsequent paragraphs.

In embodiments, members may be required to abide by terms and conditions as part of their participation in the incentivized peer-to-peer distribution system. For example, members may be responsible for educating the customer about the requirement to pay the content distribution system for any content they use. Further, the members may take licenses from the content distribution system, to possess and pass forward content without payment. However, the members may be compelled under license agreement to pay for the products they consume, unless they consider the product to be defective or otherwise below standards.

In embodiments of the present invention, a sponsor may also be responsible for educating customers regarding the need of registration with the content distribution system to be covered by the licensing provided by the system. For example, the present system may supply copies, email templates and PDFs to aid the sponsor in supplying information for educating downstream distributors about product registration. Members may be prohibited from editing or changing a product or content other than to facilitate distribution to a particular device or set of devices. Further, when distributing products or content, the sponsor must ensure that correct naming conventions are used for files. Likewise, if the file is a playable disk, correct metadata may be included for identification as a ready version for the incentivized peer-to-peer distribution system.

In embodiments of the present invention, a member may tag a product for purchase. To tag a product the member may need to supply information such as sponsor mobile number, member mobile number, product code, and the like. Further, the system of the present invention may include a repository of preview files that may be available for scrutiny and identification of a work.

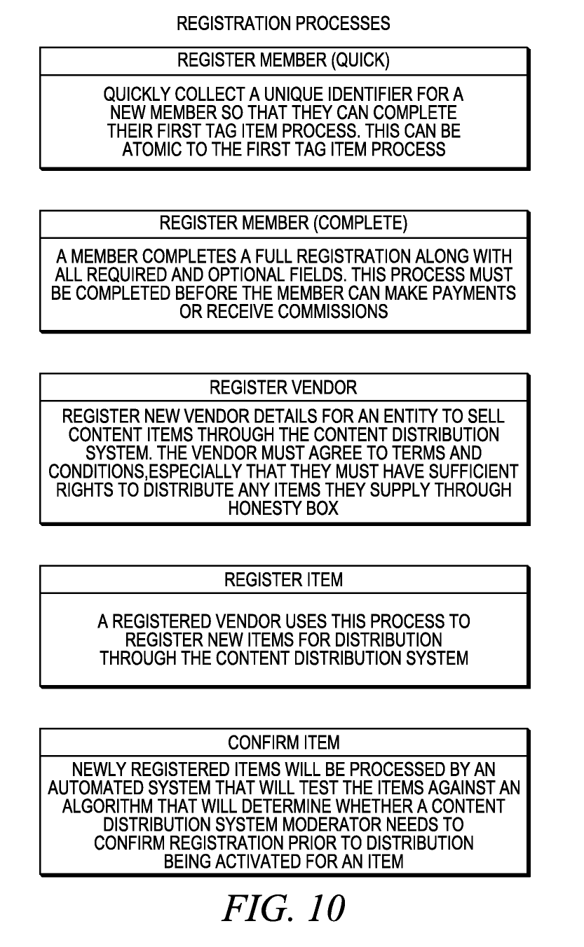

In an embodiment of the present invention, the incentivized peer-to-peer distribution system may maintain accounts for each vendor, sponsor, and member. To create an account within the incentivized peer-to-peer distribution system, the vendor, sponsor, or member may need to provide a unique identifier. The unique identifier may be a mobile phone number as the mobile phone numbers are globally unique and may be easily confirmed. FIG. 10 provides a simplified summary of components of the registration process of the incentivized peer-to-peer distribution system.

In an example, a member may register within the incentivized peer-to-peer distribution system by supplying and verifying their unique identifier. The registration may include a basic registration (e.g., providing a single identifier) and/or a complete registration (e.g., providing name, address, phone number, or some other type of identifying information). The registration may be done through various modes such as by using the Short Message Service (SMS) from mobile phones, on-line registration, ground mail registration, or some other form of registration. Once a registrant has successfully completed a basic registration, the system may send text messages, or some other type of alert, as a reminder to fulfill a complete registration.

In an embodiment, the basic registration may require a member to send a text message, such as through SMS, containing information regarding a product which the member may purchase from a sponsor. The text message may include information such as <product code> <sponsor mobile number> e.g. “XCVT5Y 3106558976” to a regional short code e.g. for the USA: 77880. In an embodiment, the country code may be left out as the country may be implied by the regional short code. The member may register with the incentivized peer-to-peer distribution system by successfully sending the text message. Further, the member may register a first product to be purchased. Once this is accomplished, additional products may be tagged for purchase using the same method.

In another embodiment, a member may opt for on-line registration. The member may send information such as mobile phone number and a product code. The product code may be optional. Further, the member may be required to enter a password/PIN sent to their handset from the content distribution system. Thereafter, the member's mobile phone number may be registered against their account.

In an embodiment of the present invention, once a customer has completed their basic registration, the reminder facility of the incentivized peer-to-peer distribution system may send text messages to remind the customers about completing their registration. Further, the customers may be required to complete the registration prior to completing payment of products from their accounts. Moreover, the customers may not be able to receive the rewards, such as royalty payments, until the complete registration has been done. For completing the registration process, a customer may be asked to provide optional information and required information. The optional information may include last name of the customer, date of birth of the customer, state, town/city, zip/postal code, gender, photo, Facebook username, Twitter username, mailing list opt in, or some other type of identifying information. The incentivized peer-to-peer distribution system may use, for example, Facebook information of a customer to notify the customer regarding immediate downstream purchase information and/or purchase/license opportunities. Likewise, the incentivized peer-to-peer distribution system may send Twitter “tweets,” or some other type of content push, regarding each immediate downstream purchase and/or purchase/license opportunity. Information such as date of birth of the customer, zip/postal code may be required by some geographic jurisdictions, in which case this information may be identified as required information based at least in part on a country code or some other type of geographic data that is associated with a user and/or a user's mobile phone or residence. In an example, the required information may include first name of the customer, mobile number of the customer, account number of the customer, an e-mail id of the customer, a password, country of residence of the customer, acceptance of terms and conditions of the WOM content distribution system, and the like. The password mentioned herein may refer to a default password that may be assigned to the customer once the customer completes the basic registration.

In an embodiment of the present invention, a vendor may serve as a sponsor for the various products and content that they vend through the incentivized peer-to-peer distribution system. The vendor must have sufficient rights to be able to sell or license products and contents assigned to them. In an example, a vendor may be a creator of a product or content item that is made available through the incentivized peer-to-peer distribution system Alternatively, vendors may license or purchase the products or content from actual content owners/creators, and thereafter may sell and/or license the products or content through the incentivized peer-to-peer distribution system.

In an embodiment, each product or content may be limited to having only one vendor in the incentivized peer-to-peer distribution system. The vendor may be the first point of distribution for a product with the IDC emerging from them.

In the system of the present invention, vendors may need to agree to abide by terms and conditions that are required by the incentivized peer-to-peer distribution system. For example, the vendors may be required to warrant that they have the necessary rights to sell or license the product or content. The content distribution system may retain rights to remove products and content from a vendor, in a case where it is discovered that the vendor is not properly entitled to sell the product or content. In embodiments, the incentivized peer-to-peer distribution system may co-operate with rightful owners to obtain and reimburse any earnings from fake vendors.

In embodiments, vendors may be required to allow members to possess and use products under a distributorship agreement with the incentivized peer-to-peer distribution system. Vendors may be liable for any damages caused by incorrect or wrongful registration and distribution of content within the content distribution system.

As mentioned above, the product vendors may be the creator/owner of the products. Therefore, any licensing requirements may be the responsibility of the vendor who will be required to warrant their rights to the products. The vendor may also be required to indemnify the incentivized peer-to-peer distribution system against any damages that may arise due to illegal listing of the products by the vendor for sale. In addition, the vendor may be required to tick a box for each requirement by a product type to confirm that the vendor has the necessary rights in place to distribute the product.

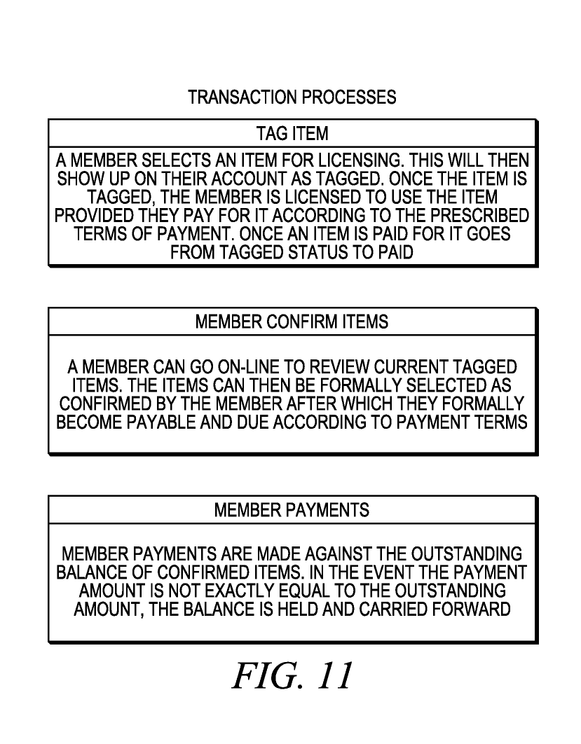

In embodiments, the present invention may provide a transaction and licensing process for enabling customers to license product and content. Customers may mark the products or content that they may wish to license, have this data recorded in their customer account within the incentivized peer-to-peer distribution system, and be billed for such licenses at a later date. In an exemplary embodiment of the licensing process, a customer may send a text message to a short code that may fetch a response from the incentivized peer-to-peer distribution system. For example, the customer may send a message containing <(product code/s)> <sponsor mobile> such as “XCVRT5 3109876543” to a short code of the content distribution system. Upon receiving the text message the content distribution system may automatically send a response to the customer such as “Honesty Box: Thanks! You have licensed product XCVRT5. Please go to www.epifne.com to pay within 30 days. Enjoy!”. FIG. 11 provides a simplified summary of components of the transaction process of the incentivized peer-to-peer distribution system.

In embodiments, customers may apply on-line for a license. For example, customers may log in to www.epifne.com, or some other location, using their mobile number, unique identifier, email address, or some other type of identifying information. A password may be required in addition to the unique identifier. Thereafter, customers may enter the product codes for the products or content that they wish to license. Finally, the customers may press a ‘license now’ button to finish the process.

In an embodiment of the present invention, different product and content types may have varying complexity with regard to licensing. For example, a music product may have mechanical recording, publishing & performance royalties associated with it. In another example, a video product may have music synchronization royalties.

As described above, when a member tags a product for purchase, the member may need to supply information such as sponsor mobile number, member mobile number, product code, and the like. This information may be supplied to the incentivized peer-to-peer distribution system in a number of ways such as by using web 2.0 widgets hosted by sponsors, web sites hosted by sponsors that hand-off to the content distribution system web site, using the incentivized peer-to-peer distribution system website itself, sending a text message to a regional short code, an archive file with the sponsor Id being encoded in the archive file, using a device-to-device transfer where an archive file containing the sponsor ID may be transferred to a receiving device, and the like. Further, the IDC may be calculated by progressive supply of information pertaining to product purchases.

In embodiments of the present invention, the incentivized peer-to-peer distribution system may provide a smart archive facility. The smart archive facility may facilitate tagging of products and content, and facilitate registration of the sponsor of the archive file. When the archive file is created, the sponsor may be prompted to include their sponsor ID (e.g., mobile phone number). Thereafter, when the archive file is opened by a third party for content extraction, a smart archive software application may ask the customer for their cell number, or other unique identifier, and the products or content that they wish to extract. The customers may then register within, for example, a web site of the incentivized peer-to-peer distribution system.

In an embodiment, the system of the present invention may provide a device-to-device smart archive facility. This facility may enable devices to have the incentivized peer-to-peer distribution system functionality installed on the device whereby the owner of the device may configure it with their sponsor ID and not be required to manually login to a website in order to interact with the incentivized peer-to-peer distribution system. Further, vendors may be able select products to be transferred to another device, and specify the transfer protocol to be used, such as Bluetooth, WiFi, near field communications, or some other transfer means. In embodiments, near field communications (NFC), as used herein, may refer to a plurality of NFC communication protocols utilizing a short-range, high frequency wireless communication technology, including short range wireless RFID technology, that makes use of interacting electromagnetic radio fields which enables the exchange of data between devices that are near to one another. NFC, as used herein, includes, but is not limited to NFC communication protocols that are extensions of the ISO/IEC 14443 proximity-card standard. In embodiments, NFC may communicate and transfer data via magnetic field induction. In embodiments, NFC may operate in a passive mode whereby one device is active and a second, or more devices are passive, or it may operate in an active mode in which more than one device is active and able to send and receive data with other devices within a close proximity to the active device. NFC, as used herein, includes but is not limited to the technologies that are based on the specifications developed by the NFC Forum, including but not limited to: the NFC Data Exchange Format, NFC Tag Types, NFC Record Type Definition, Smart Poster RTD, Text RTD, Uniform Resource Identifier TRD, Generic Control Record Type Definition RTD, Connection Handover Specification, or some other NFC Forum specification or technology protocol.

Transfers may be performed using the smart archive facility to encapsulate the archive files. When a receiving device opens the archive file it may store and process the smart archive, thereby allowing the recipient to nominate the products they want to license. In an embodiment, the licensing of content may be an automated component of the content transfer. For example, in the instance of a device-to-device transfer, such as a phone-to-phone transfer, the act of transfer may send a notification to the distribution system indicating that a license is granted to the new user that is the recipient of the content transfer. Nominated products and content that the customer using the receiving device selects to license may then be recorded in that customer's incentivized peer-to-peer distribution system account. If the customer does not already have an account, a temporary account may be created using a basic registration process, as described herein. Upon logging into the incentivized peer-to-peer distribution system, the customer may be required to update the basic registration by providing a complete registration. At this point in the process, the customer may also be provided functionality to select or deselect products or content previously selected, and to purchase a license to the selected content. Once the customer has paid for a license to the product or content, that customer may be designated as a distributor of that product or content and allowed to participate in shared rewards, such as royalties, that are derived from purchases made by subsequent customers that receive the product or content from the customer.

In embodiments, the methods and systems of the content distribution system, as described herein, may be compatible with audio playback devices, such as MP3 players, iTunes, Windows Media Player, or some other media playback device, and enabled to check for a licensing status of a content item while a member of the content distribution system is playing a track or song. An audio player may capture the member's ID, the member may provide it, and/or a member's mobile phone number, email address, or other data may be used as the ID.

In another embodiment of the present invention, if an archive product or content file is re-transferred to yet another device, the archive file transfer software may alter the sponsor ID associated with the archive file to include that of the next recipient. In an embodiment, an archive file may be named using a naming convention that allocates the last characters to the member ID of the Sponsor prior to distribution as a way of informing the Sponsor ID to the customer for later entry into the content distribution system.

In embodiments, the incentivized peer-to-peer distribution system may enable device-to-device content transfers using transfer protocols including, but not limited to, WiFi, Bluetooth, cellular network, wired network, the Internet, an intranet, a cloud computing facility, a cloud computing facility that is accessible through the smart archive application, FTP, SMS, VoIP, mesh network, or using some other transfer protocol. In embodiments, the device-to-device, or peer-to-peer transfer may be made using a structured or an unstructured system.

In another embodiment of the present invention, the incentivized peer-to-peer distribution system may include an IDC reward facility. The IDC reward facility may facilitate rewarding every sponsor for the purchase of all downstream distributors. The number of generations in the IDC that are permitted to participate in the rewards may be limited or unlimited.

In another embodiment of the present invention, the incentivized peer-to-peer distribution system may provide one or more software applications. These software applications may be run by the members on a computer, mobile phone, mobile device, or some other type of digital processing facility. Further, the software application may allow a vendor, sponsor, distributer, or customer to browse for files by keyword, product code, or some other identifying characteristic within incentivized peer-to-peer distribution system. The software application may allow a user to select products and content for purchase or license, and the software application may then bulk tag such files for registering the files for payment within the user's account. Alternatively, the software application may facilitate the user to register the files for payment by allowing the user to select the files for tagging, input the sponsor mobile phone number, input their password and submit the files.

In embodiments, the incentivized peer-to-peer distribution system may provide distribution tools that automate the distribution process, whereby files may be selected and packaged for distribution by the software application.

In embodiments, the system of the present invention may allow on-line registration of products by vendors. Information required for the registration of products may vary according to a category of the product. The essential information may include a vendor ID; a title owner; a title type that may be selected from a list; a title code that may be generated by the system; a title name; a price code that may translate into different pricing in multiple currencies depending on territory; a title type, for example, music, video, text, font, and the like; a data file that may include a digital copy of the product that may be stored by the content distribution system for identification purposes; and the like. Optionally, description of the product may also be included for registering the product.

In an example, if the title type is music, details such as artist, publisher, record company, and the like may be required for completing the product registration.

In an embodiment of the present invention, the incentivized peer-to-peer distribution system may require indemnification from vendors with regard to any damages that may arise due to misuse of the system. In addition, the system may put measures in place whereby the system may systematically detect titles by known artists and either reject them or tag them for human scrutiny.

In another embodiment, the system of the present invention may use a product code to uniquely identify titles submitted to a catalogue by content vendors. The product code may include a 6 alpha-numeric character system generated code. The code may be uniquely generated and may omit digits 1, 0, and letters I, O to avoid ambiguity. The 6 characters under this system may allow for 1b Product Codes. Adding a further digit once this is depleted will allow for 34b Product Codes.

In embodiments, products and/or content may be distributed as a file. In such cases, the last 6 letters of the filename may be allocated by the incentivized peer-to-peer distribution system. For example, a user may rename a file to the correct format by going to the web site of the content distribution system and may conduct a search by a title. For example, the song “Faith” by the independent artist Lee Safar might be “Lee_Safar_Faith_XJTQ93.mp3”. Where XJTQ93 may be the product code issued by the incentivized peer-to-peer distribution system. The product code may be used by the content distribution system to uniquely identify titles submitted to the catalogue, by the content vendors. The product code may also be embedded in the file header, whereby, eventually, players may be able to display the product code. Further, the players may also facilitate payment by accepting a username and password from the customer.

In an embodiment of the present invention, products and/or content may be distributed as a playable disk. For example, the content distribution system may work with content producers to have a lead in a sequence introduced. The sequence may invite a payment from the content distribution system and quote the product code and follow the registration procedure as described above (e.g. via SMS, on-line, and the like). The customer may also be invited to copy the content of the playable disk and pass it on. In an embodiment, a public performance (live or recorded and replayed) may be preceded by a visual or aural prompt to text a product code to the content distribution system to register for payment. This could be applied to outdoor cinema, street theatre, or the like.

In embodiments, the incentivized peer-to-peer distribution system may not act as a distributor of a product. The system may instead store a version of the product for the purpose of identification of the work and require that the actual distribution of a product or content item be done by a customer/member.

In an embodiment of the present invention, the incentivized peer-to-peer distribution system may identify and label a customer user as a super-distributor. The super-distributor may be a person or company who may intend to make substantial profits by distributing the products that may be registered with the content distribution system. The super-distributor may accumulate a large informal network of members in their communities. The super-distributors may create their own membership system with these members. For instance, a sponsor or member may offer prizes to distributors that consistently promote products downstream effectively.

In an embodiment, the system of the present invention may enable an informal distribution network. The informal distribution network may include passing content files from a sponsor to a member via email or storage media. In embodiments, revenues may be obtained by the system and may be distributed on a per product basis. For example, revenues may be shared across entities, such as:

| | |
|---|---|
| Content Vendor | 77.0% |
| Incentivized P-to-P System | 3.5% |
| PayPal/Credit Card | 3.0% |
| IDC Reward | 16.5% |

Further, the incentivized peer-to-peer distribution system may provide a web site for facilitating a sponsor to fill out a web form to have products emailed to members' care of the system (but uploaded by a sponsor). Using this facility, the emails may include embedded links which, if followed, may uniquely identify the sponsor and the products tagged. The member may then validate the tagged products on the web site.

In embodiments, the present system may provide a long cycle shopping cart with an additional feature of using the products prior to buying the products. In addition, the incentivized peer-to-peer distribution system may provide rewards at the end of a month, or some other time period, for selling products and content. The rewards that may be earned by the sponsors may depend on the number of generations that have become member of the IDC. For example, a sponsor may receive a specific percentage of retail price based on a pattern. An exemplary pattern may be seen in the following table:

| Gen 1 | Gen 2 | Gen 3 | Gen 4 | Gen 5 | Gen 6 | Gen 7 | Gen 8 | Gen 9 | Gen 10 |
|---|---|---|---|---|---|---|---|---|---|
| 5% | 4% | 3% | 2% | 1% | 0.5% | 0.4% | 0.3% | 0.2% | 0.1% |

The above table may represent the percentage of retail price that may be rewarded to a sponsor over a distribution cycle that includes ten generations. Similarly, the percentage of reward may vary based at least in part on the number of generations that are included within the distribution cycle. It may be noted that as described herein each downstream member in turn may become a sponsor for each downstream distributor from them. Further, a sponsor may only be qualified for a reward when the sponsor has paid for their copy of the product.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed:

1. A method, comprising a computer having a computer readable medium having stored thereon instructions which, when executed by a processor of the computer, causes the processor to perform the steps of:
associating metadata with a digital file, wherein the metadata is comprised of at least one of:
a. a digital tag identifying the content of the digital file,
b. a digital tag identifying a sponsor,
c. a digital tag identifying a customer, and
d. a digital tag specifying a license term relating to the use of the digital file by a customer;
receiving an indication of a transmission of the digital file from a client device that is associated with a first consumer to a client device that is associated with a second consumer, wherein the transmission from the first consumer to the second consumer occurs within an informal distribution chain; and
updating the metadata associated with the digital file to include a digital tag identifying the second customer within the informal distribution chain and a digital tag indicating that the digital file was received by the second customer from the first customer.

2. Further comprising the method of claim 1, wherein the metadata associated with the digital file is further updated to include digital tags identifying a plurality of additional customers that are added to the informal distribution chain and the customers from whom the digital file was received.

3. The method of claim 1, wherein the metadata is stored within code of the digital file.

4. The method of claim 1, where the metadata is stored in a location remote to the digital file.

5. The method of claim 4, wherein the location remote to the digital file comprises a server that is associated with a content distribution system, wherein the content distribution system enables at least in part management and distribution of digital files.

6. The method of claim 1, wherein the license term states at least in part a duration of time that the digital file may be used by a customer in the informal distribution chain without payment.

7. The method of claim 1, wherein the transmission of the digital file from the first customer to the second customer causes the second customer to be automatically searched for within a content distribution system and registered with the system if the search does not find the second customer within the system.

8. The method of claim 7, wherein the registration of the second customer is based at least in part on using a phone number associated with the second customer as a membership identifier within the content distribution system.

9. The method of claim 7, wherein the registration of the second customer within the content distribution system includes an automated query for the second customer to enter a payment account to associate with the second customer's membership.

10. The method of claim 1, wherein the client device is an audio visual playback device.

11. The method of claim 1, wherein the client device is a cellular phone.

12. A method, comprising a computer having a computer readable medium having stored thereon instructions which, when executed by a processor of the computer, causes the processor to perform the steps of:
receiving a first indication of a transmission of a digital file from a first consumer to a second consumer, wherein the transmission from the first consumer to the second consumer occurs within an informal distribution chain, and wherein the first indication of the transmission is received at a server associated with a content distribution system that includes at least one web service;
updating metadata associated with the digital file to include a first digital tag identifying the second consumer within the informal distribution chain and a second digital tag indicating that the digital file was received by the second consumer from the first consumer;
receiving a second indication of a transmission of a digital file from the second consumer to a third consumer, wherein the transmission from the second consumer to the third consumer occurs within the informal distribution chain, and wherein the second indication of the transmission is received at the server associated with the content distribution system;
updating metadata associated with the digital file to include a third digital tag identifying the third consumer within the informal distribution chain and a fourth digital tag indicating that the digital file was received by the third consumer from the second consumer;
receiving a payment at the content distribution system from the third consumer, wherein the payment enables at least a continued, licensed use of the digital file by the third consumer; and
distributing a first royalty to the first consumer and a second royalty to the second consumer upon receipt of the payment from the third consumer, wherein the first and second royalty amounts are based at least in part on a position of the first and second consumers within the informal distribution chain.

13. The method of claim 12, wherein the first and second royalties are monetary payments.

14. The method of claim 12, wherein the first and second royalties are reward points.

15. The method of claim 14, wherein the reward points are redeemable for goods and services through the content distribution system.

16. The method of claim 12, wherein the first royalty is paid into a payment account that is associated with the first consumer's membership in the content distribution system, and wherein the second royalty is paid into a payment account that is associated with the second consumer's membership in the content distribution system.

17. A method, comprising:
receiving at a server associated with a content distribution system an indication of a transmission of a digital file from a client device that is associated with a first consumer to a client device that is associated with a second consumer, wherein the transmission from the first consumer to the second consumer occurs within an informal distribution chain and is made using a near-field communication protocol; and
updating metadata associated with the digital file to include a first digital tag identifying the second consumer within the informal distribution chain and a second digital tag indicating that the digital file was received by the second consumer from the first consumer.

18. The method of claim 17, wherein the near-field communication protocol is Bluetooth.

19. The method of claim 17, wherein the updated metadata is automatically transmitted to the server that is associated with the content distribution system.

20. The method of claim 17, wherein the updated metadata is stored locally on the client device that is associated with the second consumer, and automatically transmitted to the server that is associated with the content distribution system upon the second consumer logging in to his content distribution system web service account.
